(19) United States
(12) Patent Application Publication
(10) Pub. No.: US 2007/0008183 A1
(43) Pub. Date: Jan. 11, 2007

(54) Method, system and device for detecting and reporting traffic law violations

(76) Inventor: Yeshua Rachamim Levi, Ramat Gan (IL)

Correspondence Address: UZI EZRA HAVESHA & PARTNERS, HADAR-DAFNA HOUSE 39 SHAOUL HAMELECH STREET, TEL AVIV, 64928, IL

(21) Appl. No.: 11/480,686

(22) Filed: Jul. 5, 2006

(30) Foreign Application Priority Data
Jul. 6, 2005 (IL) 169549

(51) Int. Cl. G08G 1/054

(52) U.S. Cl. 340/937

(57) ABSTRACT

A method, system and device, to be controlled by appropriate government authority, to detect traffic offences by vehicles in real time and impose appropriate punishment according to the laws of the land. The intention of the invention is to reduce traffic offences and thereby reduce traffic accidents, human suffering, insurance premiums, manpower and financial loss caused by such accidents.

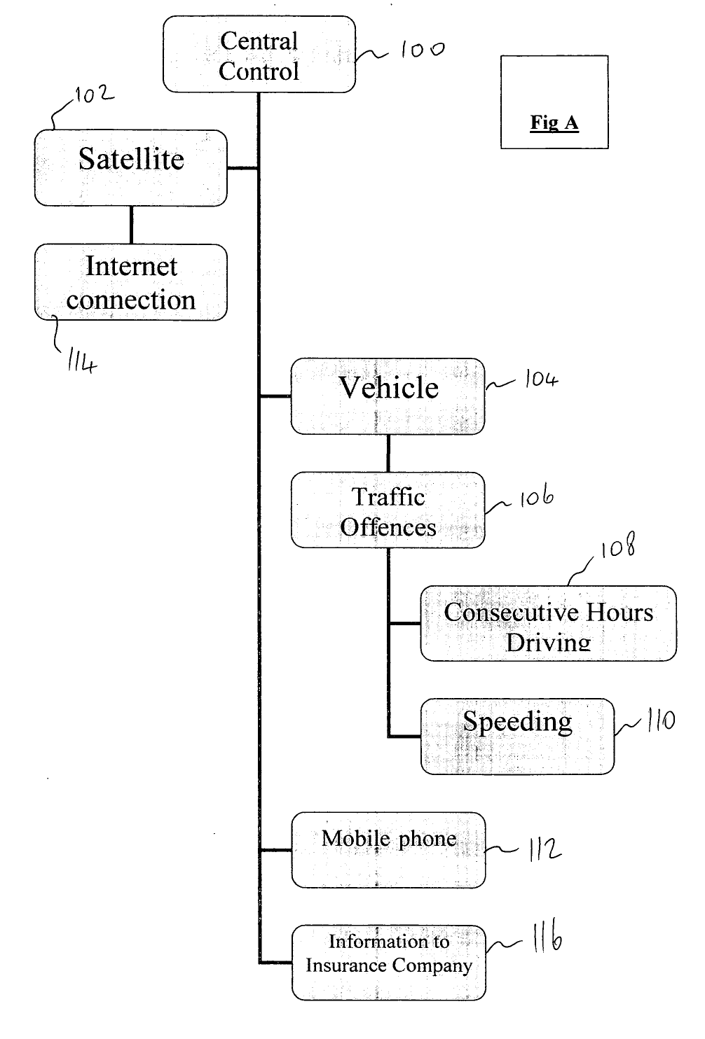

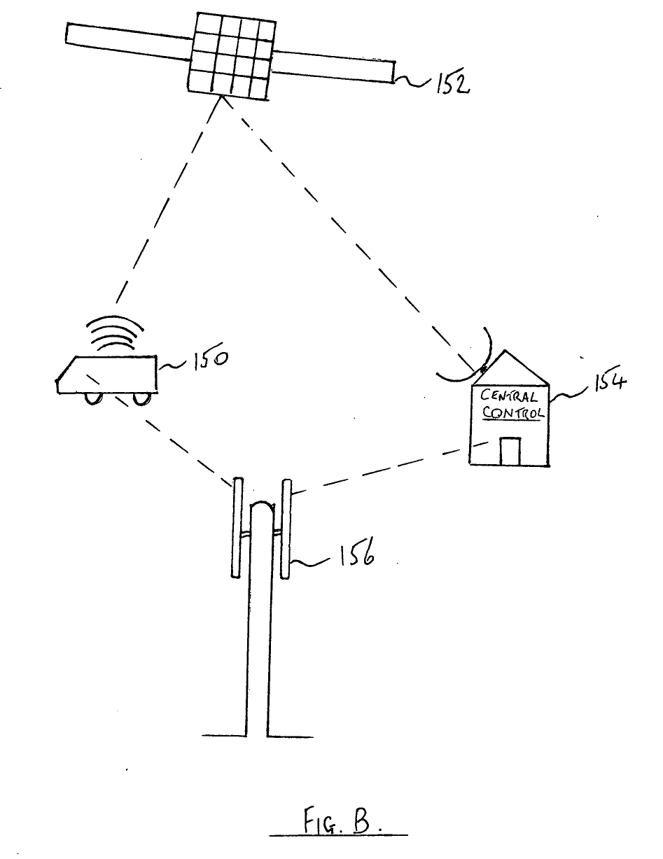

### FIELD OF THE INVENTION

A system involving various means to detect in vehicles certain parameters to assess if the driver or owner is breaking the law. That assessment is communicated to the appropriate authority that is authorized to impose punishment. The said assessment and punishment can be automated and be without human intervention.

### BACKGROUND OF THE INVENTION

This invention relates to crime detection and in particular in relation to vehicles where such crime relates to the illegal operation or status of the vehicle.

The involvement of vehicles in law infringement is well known and most statistics show that this situation has become more prevalent in recent years.

The more common crimes referred herein are traffic offenses like speeding, illegal overtaking, dangerous driving, excess consecutive hours driving, or other violation of traffic or vehicle laws or bye-laws.

The police use ever increasing quantities of manpower and constantly improved quality of electronic aids, trying to curb vehicle and traffic offences. The results are not in proportion with the effort and money spent.

It is often debated in parliaments and outside of them, how best to balance the desire to give the public, rights of privacy whilst preserving rights of the rest of the public to be protected from violations of laws designed to protect them. Decisions in such debates oscillate; first giving more rights of privacy to the individual and if that is abused too much by those taking advantage of those rights to perpetrate crime, then decisions are made to take away a portion of such rights in order to protect the public at large. This invention would probably generate such debates because it would take away certain rights of privacy that are enjoyed today by the public in most countries. The invention calls for inter alia, vehicles' speedometers to be connected using transmitters like for example the mobile phone, electronically or digitally to a satellite and computer system. Alternatively, a digital camera, for example in a mobile phone, to be installed in vehicles to monitor the vehicles' dashboard dials.

Legislation would probably have to be passed to implement this invention but the purpose of this invention is to save lives, save injuries, save suffering, reduce property damage, reduce medical expenses, reduce insurance premiums and reduce manpower losses in the workforce.

If this invention is implemented then governments will be able to justify the difficult said decisions, whereby there may be a small reduction in the rights of privacy, so heralded in “Western society” but the benefits will greatly outweigh the said restrictions to privacy.

The invention is largely computer controlled and therefore also saves police manpower while covering a vastly greater section of the driving population than presently monitored. It will save huge amounts of money spent today from public and private funds in connection with accidents, the hospital expenses, insurance payments, car repair expenses and workforce losses.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying flowchart is included to provide a further understanding of the invention, and is incorporated into and constitutes a part of this specification. The flowchart illustrates various embodiments of the invention, and together with the description serves to explain the principles and operations of the invention.

This invention utilizes an electronic device or devices for detecting the speed of vehicles and other motoring offences, for example, the number of consecutive hours driven by a driver. It then communicates the information to the relevant authorities who can either act themselves or program their computer to act for them. Such latter action can be sanctions imposed remotely by the computer program, including imposing fines and/or demobilizing the vehicle. Any interference with the proper working of the various embodiments of this invention could also be made to be an illegal act with appropriate punishments.

Communication can be with the aid of satellites and/or cellular telephone communication. Satellites could also be used to detect the position of each vehicle having the appropriate apparatus called for by this invention. This positioning would be for a number of purposes, for example, to enable the central control in charge of this invention to catch serious offenders, to see which part of a road the vehicle is traveling to determine if it is violating the speeding or other laws.

This invention also anticipates having cellular phones with imbedded video cameras in vehicles. These cellular phones would have a number of functions, for example, to photograph the speedometer and other meters in the vehicle, to transmit photographed information to an authorized authority or to accept communication from the authorized authority imposing a fine for a traffic violation. In the case of serious offences, these electronic communication systems could be used to disable the electronic system in a vehicle, for example, if the system detects interference with the apparatus of this invention. An object of this invention is to detect road crimes in real time.

Another object of this invention is to issue punishments for such road crime violations in real time.

Another object of this invention is to operate this crime detection and imposition of punishment automatically with the aid of computers and other equipment herein described, thereby increasing the quantity of violators punished while reducing the police manpower involved in traffic violation.

Another object of this invention is to reduce violation of traffic laws by making drivers realize that any traffic offence covered by this invention will be immediately punished and not be dependant upon the presence of a police car on duty.

Another object of this invention is to reduce vehicle accidents on roads, which have been shown to be directly proportional to the quantity and seriousness of traffic violations.

Another object of this invention is to prevent human suffering as a result of such accidents.

Another object of this invention is to save manpower losses and money spent as a result of such accidents.

Another object of this invention is to pass selected information to insurance companies regarding the violations and the good driving record of drivers whereby the insurance companies can raise or lower their premiums accordingly.

### BRIEF DESCRIPTION OF THE DRAWINGS

The accompanying flowchart, which is incorporated in and form a part of this specification, illustrates embodiments of the invention and, together with the description, serves to explain, by way of example only, the principles of the invention:

Fig A is a chart representing the main parties involved in this invention, namely, the central control, the vehicle in question, a monitoring device, a transmitting device and a communication aid like a mobile phone and/or a satellite.

Fig B is a schematic representation of the relationship of some of the lines of communication involved in this invention.

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the flowchart and description of the embodiments set forth below are to be regarded as illustrative in nature and not restrictive.

Fig A shows the connection between the main factors involved in this invention.

The central control 100 or whatever body is assigned to monitor vehicle offences, to bring offenders to justice and to help prevent vehicle crime, would keep a database of all relevant laws, byelaws, regulations and ordinances dealing with traffic offences or vehicle offences hereinafter referred to as “the legislation”.

The legislation would probably require vehicle owners and/or vehicle users to install in their vehicles 104, a camera for example, of the digital video variety or one being part of a mobile phone 112, for the purpose of filming and recording for example, the speedometer of the said vehicle. Alternatively, this may achieved by electronically attaching a device to the required dial, like the speedometer, and thereby recording and transmitting the readings of the said dial without the need for a filming camera.

The information collected from such filming or other device could be transferred via a satellite 102 or other communication means to the central control. Alternatively, there could be direct communication from the said detecting device(s) for example, a mobile phone 112, to the said computer for the purpose of, for example, determining if there has been an illegal act or omission and sending a notice of penalty to the driver's mobile phone 112 and/or by regular post to the address of the vehicle owner.

A computer program could be written to compare the readings of, for example, the speedometer, with the relevant part of the legislation. When there is a matching between the said readings and the legislation, that is to say a traffic offence 106 has been committed, a notice of fine or whatever punishment is prescribed by legislation, could be sent automatically to the driver or car owner. Such punishments could be notified to the driver and/or owner immediately by means of, for example, SMS technology to the driver's or user's mobile phone 112 and/or sent by post to the owner's home. Alternatively, the said camera could be imbedded in a mobile phone that would be used to convey information from the vehicle to the said computer or in the reverse direction for example, messages such as fines. Such communication by SMS or via the internet 114 is well known in the art.

Another aspect of the invention could be for the central control computer using the internet connection 114, to have communication with various parts of the car for example, the on/off switch, the mobile phone, the odometer, the fuel pump and/or the system operating and confirmation device.

In the case of the connection to the switch, this would enable the computer to switch off the ignition in such a way that it could not be switched on again without central control instruction, in the event of specified crimes of a more serious nature. It could also be used to prevent starting the engine, before the system confirmed that the embodiments of this invention were installed and in working order.

Another kind of offence monitored by this invention could be the number of consecutive hours 108 driven by a vehicle 104. This is especially desirable in cars used for commercial purposes. The travel-log document that records for example how many hours a vehicle has traveled with the same driver, during a total number of hours, could be attached to the device of this invention. The identity of the driver for this purpose could be achieved for example, with the aid of the said camera. Penalty methods described above could apply here too.

Also attached to the device of this invention could be the odometer and/or the fuel meter. The attachment to the odometer would also monitor any illegal movement of the odometer. Such movements would be compared with the legislation and the central control could act accordingly namely physical confrontation or fines or other sanctions operated automatically as herein described.

An aspect of this invention could be for the there to be a mechanism to determine if the devices of this invention are continually connected and in working order. Drivers may be tempted to interfere with the system to avoid detection. One form of indicator that this is the case could be a light or other indication on the vehicle itself. Another option could be for a self-checking system that would indicate to the processing computer that the system is not in working order. A fine or other sanction could be issued summarily as herein described.

Yet another aspect of this invention is the possibility of using existing technology where there is a transmitter device in the vehicle that would communicate with the satellite 102 and thereby determine the whereabouts of the said vehicle for purposes connected to this invention. One such purpose could be to establish if a vehicle is traveling faster than the speed limit 110, the computer would need to identify which section of the road is being traveled upon, given that on the same road the speed limits can change. Such information regarding speed limits on roads would be part of the said database. Another purpose for the said whereabouts to be known could be if the police wish to physically intercede an offender.

Another aspect of this invention is the possibility of the information collected using the various elements of this invention being communicated in whole or part to the insurance company 116 of the driver or vehicle owner whereby the said insurance company 116 could adjust the premiums charged. The intention here is for there to be the possibility of a reduction in premium for good driving habits as well the opposite.

Fig B shows some of the lines of communication involved in this invention. The relevant information regarding the vehicle 150, for example, the number and owner of the vehicle 150, the speed and its position on the road are transmitted via a satellite 152 to a central control headquarters 154. The reverse direction of communication is also needed when for example, the central control 154 or their computer issues a fine to the owner of the vehicle 150. Such communication can also be via cellular telephone antennae 156.

### GLOSSARY

For greater clarity of the claims herein:

“vehicle ordinances” includes regulations enacted by governments governing usage of vehicles.

“travel log document” includes the record of how far a vehicle has traveled during a certain time.

“remote electronic circuitry” includes apparatus for determining a violation and for issuing a citation.

“conditional transmitting” includes transmitting that takes place only if at least one condition is satisfied.

“operation status” includes whether the reporting system is turned on and operational.

“reporting system” includes a camera and a local or remote processing unit for determining compliance or violation of a traffic ordinance.

“processing unit” includes a unit that performs any method of the present invention including an ordinance database.

““reporting device” includes a server for reporting to the government.

“circuitry” includes software and hardware.

“announcement mechanism” includes a light on the roof of the vehicle”.

What is claimed: The present invention is not intended to be limited to the embodiments described above, but to encompass any and all embodiments within the scope of the following claims:

1. A method and device for law enforcement comprising
a means of maintaining a database describing parameters of at least one vehicle ordinance,
a means of acquiring an image of at least one of a display of a meter of a moving vehicle and of a travel log document printed within the said moving vehicle, and
a means of determining, on the basis of data derived from the said image and in accordance with the contents of the said database, compliance with the said vehicle ordinance.

2. A method as claimed in claim 1 wherein at least one of the said meter and camera for acquiring the said image is located within the said moving vehicle.

3. A method as claimed in claim 1 wherein the said meter is the speedometer.

4. A method as claimed in claim 1 wherein the said meter is the odometer.

5. A method as claimed in claim 1 wherein the said vehicle ordinance is selected from the group consisting of speed limitations, fair trade ordinances and number of hours of consecutive driving.

6. A method as claimed in claim 1 wherein the said means of determining is carried out a plurality of times.

7. A method as claimed in claim 1 wherein the said image is acquired at least ten times an hour.

8. A method as claimed in claim 1 wherein the said image is a video image.

9. A method as claimed in claim 1 wherein the said vehicle ordinance is a fair trade ordinance concerning, for example, interference with the odometer.

10. A method as claimed in claim 1 wherein the said means of determining is performed at least in part with the aid of remotely located electronic circuitry.

11. A method as claimed in claim 1 further comprising a means of transmitting to remote electronic circuitry data derived from the said image.

12. A method as claimed in claim 11 wherein the said transmitting includes transmitting the said image.

13. A method as claimed in claim 11 wherein the said transmitting is a conditional transmitting in accordance with one or more detected conditions.

14. A method as claimed in claim 13 wherein the said condition includes speed limit compliance.

15. A method as claimed in claim 1 further comprising a means to notify at least one law enforcement agency and a person associated with the said vehicle of determined non-compliance with the said vehicle ordinance.

16. A method as claimed in claim 1 further comprising a means to issue a citation.

17. A method as claimed in claim 1 wherein the said image is acquired by a camera embedded in a mobile telephone.

18. A method as claimed in claim 17 wherein the said mobile telephone is further operative to transmit data derived from the said image to a remote location.

19. A method as claimed in claim 1 further comprising a means to issue a citation via a telephone service provider or by an entity appointed by the said telephone service provider.

20. A method as claimed in claim 1 wherein the said determining is carried out in accordance with a determined location of the said moving vehicle.

21. A method as claimed in claim 1 further comprising a means to determine and communicate the operation status of the said device.

22. A method as claimed in claim 21 wherein the said communication is visible on a local reporting device in the said moving vehicle.

23. A method as claimed in claim 21 wherein the said communication is made to a law enforcement authority.

24. A method as claimed in claim 1 wherein the said meter has an analogue display.

25. A method as claimed in claim 1 wherein the said meter has a digital display.

26. A method and device for law enforcement comprising
a cellular telephone within a vehicle,
a location determining device,
a means to determine the location of the said moving vehicle at, at least two different times,
a means to determine compliance with vehicle ordinances.

27. A method as claimed in claim 26 further comprising
a means to carry out at least one activity selected from the group consisting of reporting non-compliance, issuing a citation, determining or adjusting an insurance rate associated with at least one of the said vehicle and a person associated with the said cellular telephone.

28. A method as claimed in claim 27 wherein the said non-compliance is reported to at least one of a law enforcement authority, the said cellular telephone, an authorized representative of an insurance company, an insurance company and an authorized third party.

29. A method as claimed in claim 28 wherein the said reporting includes sending a text message to the said cellular telephone.

30. A method and device adapted for use with a vehicle comprising
at least one meter selected from speedometer, odometer, and fuel meter,
a device for printing a travel log of the said meters,
a data camera operative to acquire an image of at least one of the said meters and said travel log, and
a processing unit operative to determine on the basis of data derived from the said image, a compliance status of the vehicle with a vehicle ordinance.

31. A method as claimed in claim 30 wherein at least a portion of the said processing unit is remotely located.

32. A method as claimed in claim 30 further comprising a transmitter for transmitting data derived from the said image to at least one of a remotely located portion of the said processing unit, an infraction reporting device and a citation producing mechanism.

33. A method as claimed in claim 30 wherein the said processing unit includes optical character recognition circuitry.

34. A method as claimed in claim 30 further comprising an announcement mechanism for announcing the operation status of the said device.

35. A method as claimed in claim 30 wherein the said data camera is embedded in a cellular telephone.

36. A method as claimed in claim 26 wherein a satellite is used to aid the said location.

37. A method and device as claimed in claims 1, 26 and 30 wherein the detection of violation is by electronic means direct in the relevant parts of the vehicle.

38. A method and device as claimed in claims 1, 26 and 30 wherein there is a means to cause the electronic operation of the said vehicle to cease to operate.

39. A method and device as claimed in claims 1, 26 and 30 wherein information regarding at least one driver's driving behavior is transferred to at least one insurance company whereby the latter may adjust its future insurance premiums accordingly.
